(19) United States
(12) Patent Application Publication
(10) Pub. No.: US 2008/0283273 A1
(43) Pub. Date: Nov. 20, 2008

(54) Semiconductive Composition and Power Cable Using the Same

(76) Inventors: Jin-Ho Nam, Gyeonggi-do (KR); Dae-Hee Cho, Gyeongsangbuk-do (JP)

Correspondence Address: STROOCK & STROOCK & LAVAN LLP, 180 MAIDEN LANE, NEW YORK, NY, 10038, US

(21) Appl. No.: 11/912,028

(22) PCT Filed: Feb. 6, 2006
(86) PCT No.: PCT/KR2006/000427

§ 371 Date: Jun. 6, 2008

(30) Foreign Application Priority Data
Apr. 21, 2005 (KR) 10-2005-0033300

(51) Int. Cl. H01B 3/28; C08L 95/00; C08L 33/08

(52) U.S. Cl. 174/110 PM; 524/69

(57) ABSTRACT

The present invention relates to a semiconductive composition and a power cable using the same. The semiconductive composition according to the present invention constituting a semi-conductive layer of a power cable includes 100 parts by weight of a base resin composed of an ethylene-based copolymer resin; 45 to 70 parts by weight of a carbon black; and 0.2 to 5.0 parts by weight of a nonionic surfactant. The semiconductive composition according to the present invention has an improved interfacial smoothness in the semiconductive layer and the insulation layer of the power cable and an increased dielectric breakdown strength of the insulation layer. Also, the semiconductive composition according to the present invention may be useful to ensure an easy cleaning property of a mold upon extruding/molding a power cable.

### TECHNICAL FIELD

The present invention relates to a semiconductive composition and a power cable using the same, and more particularly to a semiconductive composition constituting an internal or external semiconductive layer of a power cable, and a power cable using the same.

### BACKGROUND ART

Basically, semiconductive materials for a power cable should have an excellent smoothness property, as well as an excellent mechanical property for their usage, and ensure a long-term stability for a volume resistance or the like. For this purpose, an ethylene-based copolymer resin is generally used as a base resin, and an ethylene vinyl acetate resin, an ethylene ethyl acrylate resin, an ethylene butyl acrylate resin, or resin mixtures thereof are particularly used herein. The semiconductive composition includes carbon black, an antioxidant, a cross-linking agent, a processing aid, etc. in addition to the base resin.

Meanwhile, it has been known that defects in a semiconductive layer are generally caused by a lot of field focus factors, but defects such as unevenness are caused by several 10 to 100 times of stress factors more than the field focus factors. Accordingly, the unevenness should not be present in the semiconductive layer, and it is important for the semiconductive layer to have a very small unevenness although the smoothness is generated.

However, according to the prior art, it has been known that interfacial unevenness is deteriorated upon actually conducting an extrusion process using a semiconductive composition in the power cable since viscosity of a semiconductive material is increased if a large amount of carbon black is added to the semiconductive composition. In the case of semiconductive materials for an ultra-high voltage cable, their purity should be sustained at a very high level for their usage so as to improve this interfacial smoothness. For this reason, there has been used a method for filtering foreign substances, which may be included in the semiconductive materials, by installing a mesh in a region of a die upon conducting an extrusion process. However, this conventional method has technical limits in improving smoothness.

Also, the semiconductive materials for an ultra-high voltage cable may have an increased viscosity in the inside of an extrusion screw, a cylinder and a head. Therefore, the cleansing time of the head and an extrusion line may be extended after the extrusion process, and scratches may be caused in the process of removing remainders of the semiconductive materials. Accordingly, there are problems that wear and aging of equipments are accelerated due to these various factors.

Meanwhile, a semiconductive composition was often prepared by adding a small amount of ethylene propylene diene monomer to general semiconductive materials in the prior art. However, the semiconductive composition prepared according to this method has a problem that it is difficult to ensure a long-term stability for the semi-conductive materials since a density of impurities causes a fatal dielectric deterioration phenomena.

Also, processability of the semiconductive materials according to the prior art is improved when a wax is used as a processing aid. However, if a large amount of wax processing aid is used, dielectric deterioration may be caused. On the while, if a small amount of wax processing aid is used, processability improvement is not satisfactory, and therefore the wax does not ensure good effectiveness.

### DISCLOSURE OF INVENTION

### Technical Problem

Accordingly, the present invention is designed to solve the problems of the prior art, and therefore it is an object of the present invention to provide a semiconductive composition capable of satisfying mechanical properties or a volume resistance characteristic that the semiconductive materials should possess, as well as improving a smoothness property during the manufacturing process and an electrical property of an insulation layer provided in a power cable, and ensuring an easy cleaning property of an extrusion die, and a power cable including a semiconductive layer using the same.

### Technical Solution

In order to accomplish the above object, the present invention provides a semi-conductive composition constituting a semiconductive layer of a power cable, including 100 parts by weight of a base resin composed of an ethylene-based copolymer resin; 45 to 70 parts by weight of a carbon black; and 0.2 to 5.0 parts by weight of a nonionic surfactant.

In order to accomplish the above object, the present invention provides a power cable having a conductive layer, an internal semiconductive layer, an insulation layer, an external semiconductive layer and a sheath layer which are sequentially formed from the inside toward the outside of the power cable, wherein at least one of the internal and external semiconductive layers is made of a semiconductive composition including 100 parts by weight of a base resin composed of an ethylene-based copolymer resin; 45 to 70 parts by weight of a carbon black; and 0.2 to 5.0 parts by weight of a nonionic surfactant.

### BRIEF DESCRIPTION OF THE DRAWINGS

The accompanying drawings is just shown for the purpose of illustrations of preferred embodiments of the present invention, and for better understandings of technical aspects of the present invention, and therefore it should be understood that the present invention should not be construed as limited to the accompanying drawings. In the drawings:

FIG. 1 is a cross-sectional view showing a power cable according to a preferred embodiment of the present invention;

FIG. 2 is a transmission electron microscopic view showing a structure of the semi-conductive composition according to the preferred embodiment of the present invention;

FIG. 3 is a transmission electron microscopic view showing a structure of a semi-conductive composition according to the prior art; and

FIG. 4 is a schematic view showing a test model for testing an insulating performance of a semiconductive composition according to the present invention.

### BEST MODE FOR CARRYING OUT THE INVENTION

Hereinafter, preferred embodiments of the present invention will be described in detail referring to the accompanying drawings.

A semiconductive composition constituting at least one of internal and external semiconductive layers provided in the present invention includes a base resin, carbon black and a surfactant, and the semiconductive composition may further include an antioxidant, a cross-linking agent, etc., if necessary.

An ethylene-based copolymer resin is used as the base resin. More specifically, an ethylene butyl acrylate copolymer or an ethylene ethyl acrylate copolymer may be used as the base resin.

As the ethylene butyl acrylate copolymer, polyethylene butyl acrylate (a major base resin) having a butyl acrylate content of 10 to 20% by weight and a melt index of 1 to 8 g/10 min may be used alone or in combination with polyethylene butyl acrylate (a minor base resin) having a butyl acrylate content of 25 to 40% by weight and a melt index of 15 to 300 g/10 min.

As the ethylene ethyl acrylate copolymer, polyethylene ethyl acrylate (a major base resin) having an ethyl acrylate content of 10 to 20% by weight and a melt index of 1 to 8 g/10 min may be used alone or in combination with polyethylene ethyl acrylate (a minor base resin) having an ethyl acrylate content of 25 to 40% by weight and a melt index of 15 to 300 g/10 min.

The major base resin is used for the purpose of improving mechanical and electrical properties, appearance, etc. of the semiconductive composition, and the minor base resin is used for the purpose of improving its processability such as an extrusion property while minimizing deterioration of the physical properties of the major base resin.

At this time, a weight ratio of the major base resin to the minor base resin preferably ranges from 100:0 to 70:30, and more preferably from 85:15 to 75:25. This is a reason that if a content of the ethylene butyl acrylate or the ethylene ethyl acrylate as the minor base resin exceeds 30 parts by weight, based on 100 parts by weight of the base resin, it may not be used as a product since a polymeric gel component included in the resin functions as unevenness upon extruding the semiconductive material.

The carbon black is used at an amount of 45 to 70 parts by weight, based on 100 parts by weight of the base resin. Productivity is lowered due to excessively increased viscosity of the semiconductive composition if the carbon black is used at an amount of greater than 70 parts by weight, while an effect on the addition of carbon black is deteriorated if the carbon black is used at an amount of less than 45 parts by weight. Preferably, an acetylene black, or a high-purity furnace black having a sulfur content of less than 300 ppm is used as the carbon black.

The surfactant improves a dielectric breakdown strength of an insulation layer in contact to a semiconductive layer which is made of the semiconductive composition according to the present invention for a power cable, and enhances an adhesive property. The surfactant is used at an amount of 0.2 to 5.0 parts by weight, based on 100 parts by weight of the base resin. If the surfactant is used at an amount of more than 5 parts by weight, it prevents the carbon black from being uniformly dispersed and adversely affects mechanical and electrical properties and smoothness of the semi-conductive composition by acting as a barrier in a cross-linking reaction, thereby inhibiting a cross-linking degree of the semiconductive composition. Also, if the surfactant is used at an amount of less than 0.2 parts by weight, the dielectric breakdown strength of the insulator are not improved and the adhesive property is not also enhanced.

Preferably, the semiconductive composition according to the present invention may further include 0.3 to 2.0 parts by weight of an antioxidant and 0.2 to 2 parts by weight of a cross-linking agent, based on 100 parts by weight of the base resin.

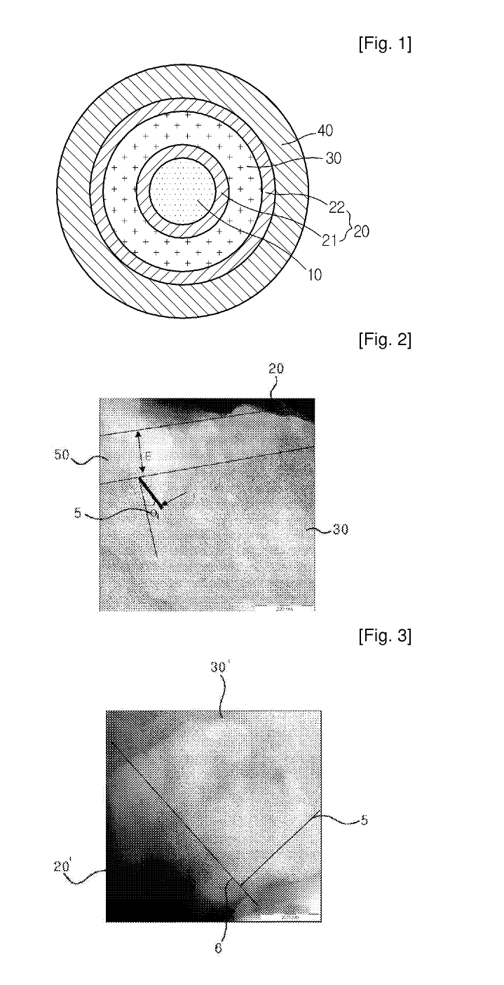

FIG. 1 is a cross-sectional view showing a power cable according to one preferred embodiment of the present invention.

Referring to FIG. 1, the power cable according to this embodiment includes a conductive layer 10, an internal semiconductive layer 21, an insulation layer 30, an external semiconductive layer 22 and a sheath 40, which are sequentially formed from the inside toward the outside. Meanwhile, the sheath layer may be subdivided into a watertightness layer which is a semiconductive absorptive tape, an aluminum shielding layer, an anti-corrosive layer, etc., and a graphite layer may be formed on the outside of the sheath layer.

The conductive layer 10 functions to transmit an electric power, and is provided in the innermost region of the power cable.

The internal semiconductive layer 21 alleviates an electric field in a surface of the conductive layer 10 since it is configured to surround the conductive layer 10, and the outside of the internal semiconductive layer 21 is insulated by the insulator 30. The external semiconductive layer 22 is provided around the insulation layer 30 so as to alleviate the electric field and protect the insulator, and the sheath 40 is provided to the outside of the external semiconductive layer 22 so as to protect a power cable from outside environments. The above-mentioned semiconductive composition of the present invention is identically used in the internal semiconductive layer 21 and the external semiconductive layer 22.

The power cable using the semiconductive composition as configured above has an improved dielectric breakdown performance and may ensure an electrical stability since it has a decreased generation of smoothness upon extruding the semiconductive composition. Also, the power cable has an easy cleaning property since an adhesivity to an extrusion die is decreased upon extruding a semiconductive layer.

FIG. 2 is a transmission electron microscopic view showing an insulation layer 30 and a semiconductive layer 20 of the power cable according to the present invention; and FIG. 3 is a transmission electron microscopic view showing an insulation layer and a semiconductive layer of the power cable according to the prior art.

Referring to FIG. 2, an interfacial layer 50 is formed between the insulation layer 30 and the semiconductive layer 20 of the power cable according to the present invention. Also, a lamella structure, that is a layered structure, is regularly arranged on the insulation layer 30. More specifically, the lamella arranged on the insulation layer 30 has a regular shape with being included at a predetermined angle when a line vertical to the interfacial layer 50 is used as a reference line 5. Referring to FIG. 3, there is, however, no interfacial layer arranged on an insulation layer 30′ and a semiconductive layer 20′ of the power cable according to the prior art, and the lamella arranged on the insulation layer 30′ has no regular pattern.

The insulation layers 30, 30′ are evaluated for an insulating performance according to a growth pattern of the above-mentioned lamella structure, and this method is referred to as a mean lamella growth angle (θa) of an insulator. This angle is represented by the following Equation 1.

θa=Σ(θi*Li)/ΣLi Equation 1

wherein, θi represents an angle formed between the reference line 5 and one unit layer in each of the lamellas having a lamella structure; and

Li represents a length of one unit layer of each lamella.

The mean lamella growth angle (θa) represented by the Equation 1 is a value obtained by measuring a growth angle of the lamella from the reference line vertical to an interfacial layer formed between a semiconductive layer and an insulation layer, and calculating a weighted mean of the growth length using a statistical qualitative analysis for indirectly measuring a density of a lamella. A lamella density increases as this mean lamella growth angle approaches “0”, resulting in improvement of the insulating performance.

As in FIG. 3, a mean lamella growth angle exceeds 30° due to the irregularly formed lamella, and therefore a good insulating performance of the insulation layer 30′ is not attained. On the contrary, the more reliable power cable may be provided due to the improved insulating performance of the insulation layer 30 if a mean lamella growth angle is less than 30° as shown in FIG. 2 in which the semiconductive layer 20 is made of the semiconductive composition according to the present invention.

### MODE FOR THE INVENTION

Hereinafter, preferred embodiments of the present invention will be described in detail for better understandings with reference to the accompanying drawings. However, the description proposed herein is just a preferable example for the purpose of illustrations only, not intended to limit the scope of the invention, so it should be understood that other equivalents and modifications could be made thereto without departing from the spirit and scope of the invention. Preferred embodiments of the present invention is provided to describe the present invention more fully, as apparent to those skilled in the art.

In the ethylene butyl acrylate copolymer among base resins used in the following examples and comparative examples, ethylene butyl acrylate 1 having a melt index of 7 g/10 min and a butyl acrylate content of 17% by weight was used as the major base resin, and ethylene butyl acrylate 2 having a melt index of 175 g/10 min and a butyl acrylate content of 28% by weight was used as the minor base resin. Also, in the used ethylene ethyl acrylate copolymer, ethylene ethyl acrylate 3 having a melt index of 7 g/10 min and an ethyl acrylate content of 15% by weight was used as the major base resin, and ethylene ethyl acrylate 4 having a melt index of 275 g/10 min and an ethyl acrylate content of 25% by weight was used as the minor base resin.

An acetylene black was used as the carbon black, and decaglyn fatty acid ester was used as the surfactant.

In Examples 1 to 3, an ethylene butyl acrylate copolymer was used as the base resin, wherein a major base resin 1 having a low melt index was used alone or in combination with a minor base resin 2 having a high melt index at a varying weight ratio of 100:0 to 70:30 so as to improve processability.

In Examples 4 to 6, an ethylene ethyl acrylate copolymer was used as the base resin, wherein a major base resin 3 having a low melt index was mixed with a minor base resin 4 having a high melt index at a varying weight ratio.

In Comparative example 1 and Comparative example 2, an ethylene butyl acrylate copolymer was used as the base resin, and the surfactant was not added in Comparative example 1 but added at an excessive amount in Comparative example 2.

In Comparative example 3 and Comparative example 4, an ethylene ethyl acrylate copolymer was used as the base resin, and the surfactant was not used in Comparative example 3 but added at an excessive amount in Comparative example 4.

Compositions of Examples 1 to 6 are listed in the following Table 1, and compositions of Comparative examples 1 to 4 are listed in the following Table 2.

TABLE 1

| | Examples | | | | | |
|---|---|---|---|---|---|---|
| | 1 | 2 | 3 | 4 | 5 | 6 |
| Ethylene butyl acrylate 1 | 80 | 70 | 100 | | | |
| Ethylene butyl acrylate 2 | 20 | 30 | | | | |
| Ethylene ethyl acrylate 3 | | | | 75 | 75 | 80 |
| Ethylene ethyl acrylate 4 | | | | 25 | 25 | 20 |
| Surfactant | 0.4 | 1 | 4 | 0.4 | 1 | 4 |
| Carbon black(acetylene black) | 50 | 70 | 60 | 60 | 60 | 60 |
| Cross-linking agent | 0.5 | 0.5 | 0.5 | 0.5 | 0.5 | 0.5 |
| Antioxidant | 1 | 1 | 1 | 1 | 1 | 1 |

TABLE 2

| | Examples | | | |
|---|---|---|---|---|
| | 1 | 2 | 3 | 4 |
| Ethylene butyl acrylate 1 | 80 | 70 | | |
| Ethylene butyl acrylate 2 | 20 | 30 | | |
| Ethylene ethyl acrylate 3 | | | 80 | 70 |
| Ethylene ethyl acrylate 4 | | | 20 | 30 |
| Surfactant | 0 | 6 | 0 | 6 |
| Carbon black(acetylene black) | 50 | 70 | 60 | 60 |
| Cross-linking agent | 0.5 | 0.5 | 0.5 | 0.5 |
| Antioxidant | 1 | 1 | 1 | 1 |

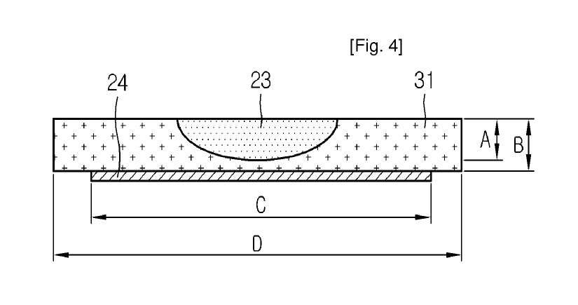

In order to show characteristics of the power cables prepared using a triple extrusion, the semiconductive compositions of the examples and the comparative examples as listed in Tables 1 and 2 were mixed to prepare model samples as shown in FIG. 4, respectively. Referring to FIG. 4, the semiconductive compositions 23, 24 according to the examples and the comparative examples were adhered to an insulator 31 made of the cross-linked polyethylene by heating upper and lower surfaces of the insulator 31, respectively. Herein, the insulation layer was actually designed at a thickness of 0.5 mm, considering that “A” is set to 4.5 mm and “B” is set to 5 mm, and “C” and “D” were designed at a length of 60 φ and 80 φ, respectively, in the model samples. Then, a dielectric breakdown strength of the insulator 31 was measured using the model of FIG. 2 prepared as described above.

Also, surface smoothness of the semiconductive compositions was measured, and then the results of the examples and the comparative examples are listed in the following Table 3 and Table 4, respectively.

TABLE 3

Examples

| | 1 | 2 | 3 | 4 | 5 | 6 |
|---|---|---|---|---|---|---|
| Dielectric breakdown | 50 | 55 | 52 | 50 | 53 | 52 |
| strength(kV/mm) | | | | | | |
| Surface smoothness | 1 | 2 | 2 | 1 | 2 | 2 |

TABLE 4

Comparative examples

| | 1 | 2 | 3 | 4 |
|---|---|---|---|---|
| Dielectric breakdown | 40 | 35 | 40 | 38 |
| strength(kV/mm) | | | | |
| Surface smoothness | 3 | 4 | 3 | 4 |

Here, the dielectric breakdown strength was measured according to an ASTM D149 method, and a dielectric breakdown voltage was measured by mounting the test piece of FIG. 2 between an upper electrode and a lower electrode, followed by increasing a voltage to 500 V/sec. The dielectric breakdown strength was calculated by dividing the dielectric breakdown voltage by the thickness of the insulator 31, and then the results obtained by measuring dielectric breakdown strengths of 20 test pieces under the separate conditions were statistically analyzed. Weibull statistics used as a conventional method for evaluating a breakdown-related reliability was used in the statistic analysis, and a value representing a breakdown probability of 63.2% is referred to as a reference value.

Also, surface smoothness levels of the semiconductive compositions according to the present invention was determined by measuring surface smoothness of the semi-conductive compositions extruded in a test Torque Rheometer using a low-magnification (×100) stereomicroscope. More specifically, a smoothness level is represented by 1 in the case of the formed smoothness of 0 to 25 um; 2 in the case of the formed smoothness of 25 to 50 um; 3 in the case of the formed smoothness of 50 to 75 um; and 4 in the case of the formed smoothness of 75 to 100 um, respectively.

Referring to Table 3 and Table 4, it was revealed that the dielectric breakdown strength is improved by 25% depending on the addition of the surfactant, comparing Example 1 with Comparative example 1. Also, it was revealed that the dielectric breakdown strength is deteriorated if the surfactant is added at an excessive amount, comparing Example 2 with Comparative example 2.

Referring to Comparative examples 1 and 3 in which the surfactant is not added to the composition, it was revealed that its surface smoothness is 3, and therefore the smoothness property is not good. Also, referring to Comparative examples 2 and 4 in which the surfactant is added at a large amount, it was revealed that the surface smoothness is 4, which is fatal to the cable performance. On the contrary, referring to Experimental examples 1 to 6, it was revealed that the surface smoothness was improved to 1 or 2.

The present invention has been described in detail with reference to the unlimiting examples and the accompanying drawings. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

As described above, the semiconductive composition according to the present invention has an improved interfacial smoothness in the semiconductive layer and the insulation layer of the power cable and an increased dielectric breakdown strength of the insulation layer. Also, the semiconductive composition according to the present invention may be useful to ensure an easy cleaning property of a mold upon extruding/molding a power cable. Accordingly, the semiconductive composition according to the present invention may be useful to ensure the reliability by improving an electric property of the power cable.

1. A semiconductive composition constituting a semiconductive layer of a power cable, comprising: 100 parts by weight of a base resin composed of an ethylene-based copolymer resin;
45 to 70 parts by weight of a carbon black; and 0.2 to 5.0 parts by weight of a nonionic surfactant, wherein the base resin is first polyethylene butyl acrylate having a butyl acrylate content of 10 to 20% by weight and a melt index of 1 to 8 g/10 min or first polyethylene ethyl acrylate having an ethyl acrylate content of 10 to 20% by weight and a melt index of 1 to 8 g/10 min.

2. (canceled)

3. The semiconductive composition according to claim 1, wherein the base resin further includes second polyethylene butyl acrylate having a butyl acrylate content of 25 to 40% by weight and a melt index of 15 to 300 g/10 min, in addition to the first polyethylene butyl acrylate.

4. The semiconductive composition according to claim 3, wherein a weight ratio of the first polyethylene butyl acrylate and the second polyethylene butyl acrylate ranges from 85:15 to 70:30.

5. (canceled)

6. The semiconductive composition according to claim 1, wherein the base resin further includes second polyethylene ethyl acrylate having an ethyl acrylate content of 25 to 40% by weight and a melt index of 15 to 300 g/10 min, in addition to the first polyethylene ethyl acrylate.

7. The semiconductive composition according to claim 6, wherein a weight ratio of the first polyethylene ethyl acrylate and the second polyethylene ethyl acrylate ranges from 85:15 to 75:25.

8. The semiconductive composition according to claim 1, wherein the carbon black is an acetylene black, or a furnace black having a sulfur content of less than 300 ppm.

9. The semiconductive composition according to claim 1, wherein the surfactant is selected from the group consisting of sorbitan fatty acid ester, decaglyn fatty acid ester, polyglycerine fatty acid ester, polypropyleneglycol and pentaerythritol fatty acid ester.

10. The semiconductive composition according to claim 1, further comprising; based on 100 parts by weight of the base resin, 0.3 to 2.0 parts by weight of an antioxidant; and 0.2 to 2 parts by weight of a cross-linking agent.

11. A power cable having a conductive layer, an internal semiconductive layer, an insulation layer, an external semiconductive layer and a sheath layer which are sequentially formed from an inside toward an outside of the power cable, wherein the internal and/or external semiconductive layer is made of a semiconductive composition, including: 100 parts by weight of a base resin composed of an ethylene-based copolymer resin;
45 to 70 parts by weight of a carbon black; and 0.2 to 5.0 parts by weight of a nonionic surfactant, wherein the base resin is first polyethylene butyl acrylate having a butyl acrylate content of 10 to 20% by weight and a melt index of 1 to 8 g/10 min or first polyethylene ethyl acrylate having an ethyl acrylate content of 10 to 20% by weight and a melt index of 1 to 8 g/10 min.

12. (canceled)

13. The power cable according to claim 11, wherein the semiconductive composition further includes second polyethylene butyl acrylate having a butyl acrylate content of 25 to 40% by weight and a melt index of 15 to 300 g/10 min, in addition to the first polyethylene butyl acrylate.

14. (canceled)

15. The power cable according to claim 11, wherein the semiconductive composition further includes second polyethylene ethyl acrylate having an ethyl acrylate content of 25 to 40% by weight and a melt index of 15 to 300 g/10 min, in addition to the first polyethylene ethyl acrylate.

16. The power cable according to claim 11, wherein the carbon black is an acetylene black, or a furnace black having a sulfur content of less than 300 ppm.

17. The power cable according to claim 11, wherein the surfactant is at least one selected from the group consisting of sorbitan fatty acid ester, decaglyn fatty acid ester, polyglycerine fatty acid ester, polypropyleneglycol and pentaerythritol fatty acid ester.

18. The power cable according to claim 11, wherein the semiconductive composition further includes: based on 100 parts by weight of the base resin, 0.3 to 2.0 parts by weight of an antioxidant; and 0.2 to 2 parts by weight of a cross-linking agent.

19. The power cable according to claim 13, wherein the semiconductive composition further includes: based on 100 parts by weight of the base resin, 0.3 to 2.0 parts by weight of an antioxidant; and 0.2 to 2 parts by weight of a cross-linking agent.

20. The power cable according to claim 15, wherein the semiconductive composition further includes: based on 100 parts by weight of the base resin, 0.3 to 2.0 parts by weight of an antioxidant; and 0.2 to 2 parts by weight of a cross-linking agent.

21. The power cable according to claim 16, wherein the semiconductive composition further includes: based on 100 parts by weight of the base resin, 0.3 to 2.0 parts by weight of an antioxidant; and 0.2 to 2 parts by weight of a cross-linking agent.

22. The power cable according to claim 17, wherein the semiconductive composition further includes: based on 100 parts by weight of the base resin, 0.3 to 2.0 parts by weight of an antioxidant; and 0.2 to 2 parts by weight of a cross-linking agent.

23. The semiconductive composition according to claim 3, further comprising; based on 100 parts by weight of the base resin, 0.3 to 2.0 parts by weight of an antioxidant; and 0.2 to 2 parts by weight of a cross-linking agent.

24. The semiconductive composition according to claim 4, further comprising; based on 100 parts by weight of the base resin, 0.3 to 2.0 parts by weight of an antioxidant; and 0.2 to 2 parts by weight of a cross-linking agent.

25. The semiconductive composition according to claim 6, further comprising; based on 100 parts by weight of the base resin, 0.3 to 2.0 parts by weight of an antioxidant; and 0.2 to 2 parts by weight of a cross-linking agent.

26. The semiconductive composition according to claim 7, further comprising; based on 100 parts by weight of the base resin, 0.3 to 2.0 parts by weight of an antioxidant; and 0.2 to 2 parts by weight of a cross-linking agent.

27. The semiconductive composition according to claim 8, further comprising; based on 100 parts by weight of the base resin, 0.3 to 2.0 parts by weight of an antioxidant; and 0.2 to 2 parts by weight of a cross-linking agent.

28. The semiconductive composition according to claim 9, further comprising; based on 100 parts by weight of the base resin, 0.3 to 2.0 parts by weight of an antioxidant; and 0.2 to 2 parts by weight of a cross-linking agent.
